(19) United States
(12) Patent Application Publication
(10) Pub. No.: US 2005/0130779 A1
(43) Pub. Date: Jun. 16, 2005

(54) Chain with a mark

(75) Inventors: Shigehisa Sudo, Nabari (JP); Hiroyuki Takeda, Nabari (JP); Takashi Fukuzawa, Nabari (JP)

Correspondence Address: BORGWARNER INC., POWERTRAIN TECHNICAL CENTER, 3800 AUTOMATION AVENUE, SUITE 100, AUBURN HILLS, MI, 48326-1782, US

(73) Assignee: BorgWarner Morse TEC Japan K.K., Nabari City (JP)

(21) Appl. No.: 10/979,426

(22) Filed: Nov. 2, 2004

(30) Foreign Application Priority Data
Dec. 10, 2003 (JP) 2003-411727
Dec. 17, 2003 (JP) 2003-419107

(51) Int. Cl. F16H 9/00; F16G 1/28; F16G 13/02

(52) U.S. Cl. 474/213; 474/212; 474/206; 474/202

(57) ABSTRACT

A chain for driving and engagement of at least one sprocket including plurality of interlaced link plates and a plurality of guide plates. The link plates are pivotably connected by connecting pins. The plurality of guide plates are disposed along the link plates and guide the chain on the sprocket in a width direction. At least one of the guide plates has a flat portion and a crotch portion and is in line with a marked position on the sprocket.

### REFERENCE TO RELATED APPLICATIONS

This application claims an invention, which was disclosed in Japanese Application No. 2003-419107, filed Dec. 17, 2003, entitled “CHAIN WITH A MARK” and in Japanese Application No. 2003-411727, filed Dec. 10, 2003, entitled “CHAIN WITH A MARK.” The benefit under 35 USC §119(a)-(d) or §365(b) is hereby claimed, and the aforementioned applications are hereby incorporated herein by reference.

### BACKGROUND OF THE INVENTION

1. Field of the Invention

The present invention relates to a timing chain wrapped around a plurality of sprockets that require synchronistic operation in an internal combustion engine and a random chain having at least two kinds of link plates that are arranged in a random pattern. More particularly, the present invention relates to a chain where the position that should correspond to the timing mark of the sprocket or the position that is a starting point of a random pattern is shown by a guide plate.

2. Description of Related Art

In a timing chain used for cam timing in an internal combustion engine, a predetermined timing mark is provided to drive a plurality of sprockets in a synchronistic manner. The timing mark is provided on the timing chain as well as on the sprocket. Synchronistic operation of a plurality of sprockets is achieved by conforming the timing mark of the timing chain to the timing mark of the sprocket.

A method of providing a timing mark on a timing chain by coloring an outside plate by applying a baking finish or plating to distinguish the outside plate from the other remaining outside plates is known in the art, as shown in Japanese patent application laid-open publication No. 9-242829. Since additional process such as applying a baking finish or plating is required in the manufacturing process of timing chains. A special facility for such a process is necessary, thus increasing manufacturing cost.

Japanese patent application laid-open publication No. 2003-240061 shows a chain where a link plate acts as a timing plate having a notch formed on the engaging side with the sprocket provided at a position corresponding to the timing mark of the sprocket in lieu of a guide plate.

In this case, since the link plate acts as a timing mark, additional processes such as baking finish or plating are not required, however, because the link plate has a notch formed on the engaging side with the sprocket is used as a timing plate, there is no guiding portion for the sprocket where the timing plate is present. Therefore, a chain may disengage from the sprocket. Furthermore, the tensile strength of the guide rows having the guide plate differs from the tensile strength of guide rows having a link plate in lieu of the guide plate. Therefore, after pre-stress operation, in which the excessive tensile load is applied, the chain pitches will vary.

The present invention is directed to providing a marked chain that can not only reduce manufacturing cost but can also prevent disengagement of the chain from the sprocket and maintain the strength of the chain uniformly.

### SUMMARY OF THE INVENTION

A marked chain according to the present invention is includes of a plurality of link plates for engagement with a sprocket and a plurality of guide plates disposed on opposite sides of the chain to guide the chain on the sprocket in the width direction during engagement with the sprocket. At a marked position, a guide plate is provided that has a backside shape different from those of the other remaining guide plates.

According to the present invention, the guide plate acting as a mark only has a backside shape different from those of the other remaining guide plates. The guide plate with the mark also provides a guiding function of a chain relative to the sprocket in the same manner as the other remaining guide plates. Thereby, the chain is securely guided on the sprocket and prevented from being disengaged from the sprocket. Moreover, no baking finish or plating of a guide plate is required, thereby decreasing manufacturing cost.

The marked chain may be a timing chain for driving a plurality of sprockets in a synchronistic manner. A guide plate is provided at a marked position corresponding to a timing mark of a sprocket a guide plate (or a timing plate) having a different backside shape from those of the other remaining guide plates.

Alternatively, the marked chain is a random chain where at least two types of link plates having different engagement pitches are arranged in a random pattern in the longitudinal direction of the chain. At a position corresponding to the starting position of the random pattern is a guide plate having a different backside shape from those of the other remaining guide plates.

The guide plate disposed at the marked position may have a crotch portion on the backside. Alternatively, the guide plate disposed at the marked position may have a flat backside surface and the other remaining guide plates may have crotch portions on their backsides.

In a third embodiment of the present invention, the guide plate disposed at the marked position may have a flat backside surface and have not been subject to pre-stressing. The other remaining guide plates may have crotch portions on the backsides thereof and have been pre-stressed.

In this case, the guide plate having the flat backside surface has a greater rigidity than the other remaining guide plates that have not been pre-stressed. The other remaining guide plates having crotch portions with relatively low rigidities, that have been pre-stressed, equalizes the yield loads of all of the guide plates with each other, thus making the strength of the entire chain uniform.

In the manufacturing process of a marked chain of the present invention, first, pre-stressing of a chain with the other remaining guide plates interlaced is conducted, and thereafter, the guide plate is installed at the marked position of the chain.

In a fourth embodiment, each of the guide plates has a generally flat surface on one side of the chain across the pin aperture centerline and a crotch portion on the other side of the chain across from the pin aperture centerline. At a marked position, an upside-down guide plate is provided to form a different backside shape from the other guide plates disposed adjacent to the upside-down guide plate.

In this case, the guide plate disposed at the marked position is the same kind of plate as the other guide plates, thereby equalizing the tensile strength of the guide rows and maintaining a uniform tensile strength of the whole chain. Also, since the guide plate does not require a baking finish or plating, manufacturing cost is reduced. Moreover, because all of the guide plates are the same, just placed in a different orientation, the manufacturing cost is further reduced.

In a fifth embodiment, the distance between the pin aperture centerline of the guide plate and the outermost edge portion of either the backside edge portion or the opposite edge portion of the guide plate is equal to or smaller than the distance between the pin aperture centerline of the link plates forming the chain and the backside surface.

In this case, even when a guide plate is assembled into the chain upside down, the outermost edge portion of the guide plate on the backside do not protrude outwardly from the backside of the link plates, which thereby prevents local wear of the tensioner arm or chain guide contacting the backside of the chain during operation.

Alternatively, the distance between the pin aperture centerline of the guide plate and the backside edge portion of the guide plate is equal to the distance between the pin aperture centerline of the guide plate and the opposite edge portion of the guide plate.

### BRIEF DESCRIPTION OF THE DRAWING

FIG. 1 is a schematic view of an engine timing system employing a timing chain of the present invention.

FIG. 2 is a front elevational view of a portion of a timing chain according to a first embodiment of the present invention.

FIG. 3 is a front elevational view of a portion of a timing chain according to a second embodiment of the present invention.

FIG. 4 is a front elevational view of a portion of a timing chain according to a third embodiment of the present invention.

FIG. 5 is a schematic view of an engine timing system employing a timing chain according to a fourth embodiment of the present invention.

FIG. 6 is a front elevational view of a portion of a timing chain according to a fifth embodiment of the present invention.

FIG. 7 is a front elevational enlarged view of a timing plate according to a sixth embodiment.

### DETAILED DESCRIPTION OF THE INVENTION

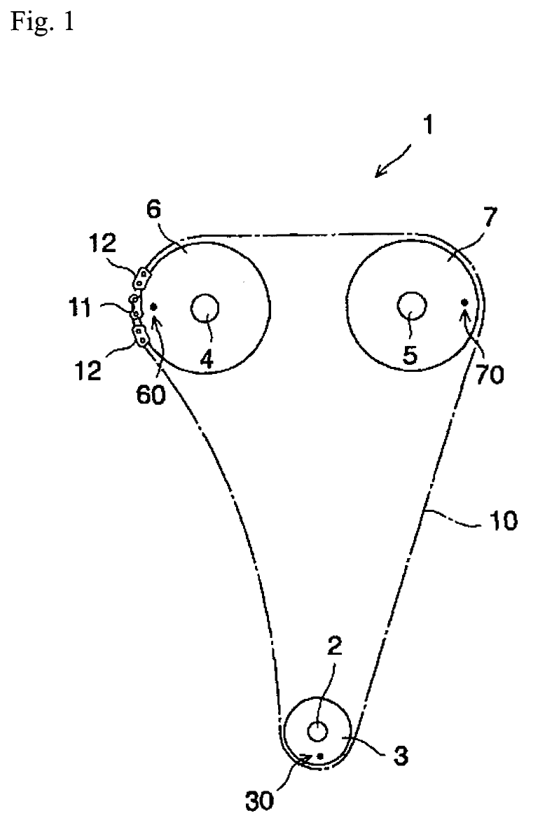

FIG. 1 shows an engine timing system employing a timing chain as a marked chain of the present invention. As shown in FIG. 1, the timing system 1 is constructed from a crank sprocket 3 mounted on a crankshaft 2, cam sprockets 6, 7 mounted on camshafts 4, 5, respectively, and a timing chain 10 wrapped around the sprockets 3, 6 and 7.

A timing mark 30 is marked on the crank sprocket 3 and timing marks 60, 70 on the cam sprockets 6, 7, respectively. The timing chain 10 has a guide plate 11 and a plurality of guide plates 12 on the outermost sides thereof. The guide plate 11 is disposed at a position corresponding to the timing mark 60 of the cam sprocket 6 and functions as a timing mark of the chain. A guide plate similar to the guide plate 11 may be disposed at positions corresponding to the other timing marks 30, 70.

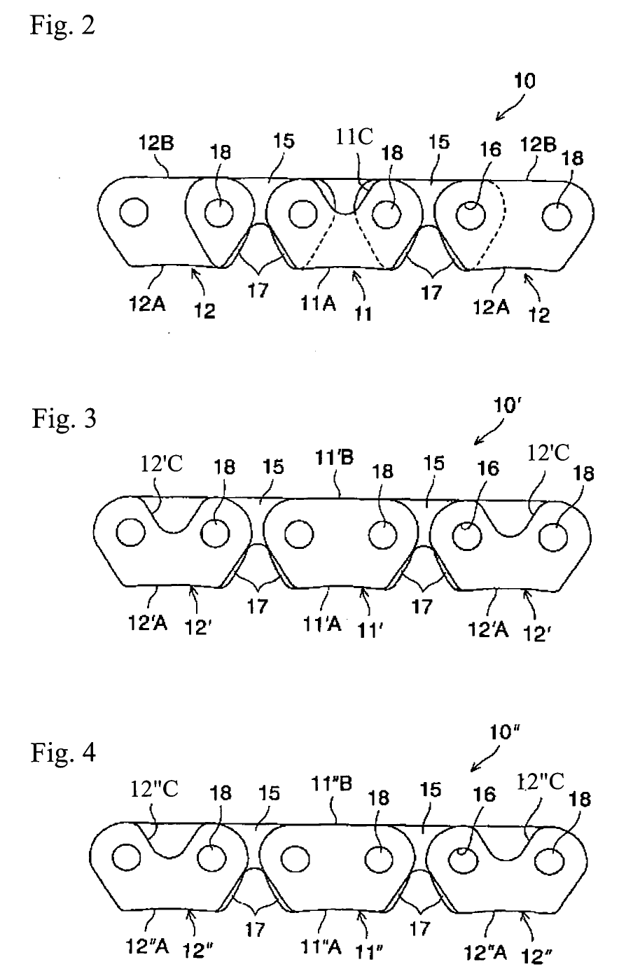

FIG. 2 shows a portion of the timing chain 10, which represents a first embodiment of the present invention. As shown in FIG. 2, the timing chain 10 includes of a plurality of rows of interleaved link plates 15 each having a pair of pin apertures 16 and teeth 17 and pivotably connected to each other by connecting pins 18 inserted into the pin apertures 16. The timing chain 1 also has guide plates 11, 12 disposed outside the outermost link plates 15 and fixedly connected to the ends of the connecting pins 18.

Each of the guide plates 11, 12 has a flat portion 11A, 12A, respectively, on the engagement side with a sprocket. These flat portions 11A, 12A are disposed on opposite sides of the sprocket during engagement with the sprocket and maintain the chain centrally on the sprocket teeth.

The guide plate 11 has a crotch portion 11C on the backside of the plate opposite the engaging side. The bottom portion of the crotch 11C extends below the upper edges of the openings of the pin apertures 16. The guide plate 12 is of a general trapezoid shape and includes a flat portion 12B on the backside.

In the timing system 1 incorporating the above-mentioned timing chain 10, the guide plate 11 or timing plate acting as a timing mark is the same as the other guide plates 12, except for the backside shape, which provides a guiding function of the chain 10 relative to the sprocket in the same manner as the other guide plates 12 during engagement with the sprocket. Thereby, the chain 10 can be securely guided on the sprocket and disengagement of the chain 10 from the sprocket is securely prevented. Also, since the guide plate 11 does not require a baking finish or plating, manufacturing cost is reduced.

FIG. 3 shows a timing chain according to a second embodiment of the present invention. In FIG. 3, like reference numbers indicate identical or functionally similar elements. The second embodiment differs from the first embodiment in that the backside shapes of the guide plate 11′ or timing plate and the other guide plates 12′ are reversed.

That is, in this case, the guide plate 11′ has a trapezoidal shape with a flat portion 11′B on the backside. Each of the other guide plates 12′ has a crotch portion 12′C on the backside.

Similar to the first embodiment, the guide plate 11′ or timing plate acts as a timing mark in the same as way as the other guide plate 12′, except the backside shape provides a guiding function of the chain 10′ relative to the sprocket in the same manner as the other guide plates 12′ during engagement with the sprocket. Thereby, the chain 10′ is securely guided on the sprocket and disengagement of the chain 10′ from the sprocket is securely prevented. Also, since the guide plate 11′ does not require a baking finish or plating, manufacturing cost is reduced.

FIG. 4 shows a timing chain according to a third embodiment of the present invention. In FIG. 4, like reference numbers indicate identical or functionally similar elements. As with the second embodiment, the third embodiment also differs from the first embodiment in that the backside shapes of the guide plate 11″ or timing plate and the other guide plates 12″ are reversed.

That is, the guide plate 11″ has a trapezoidal shape with a flat portion 11″B on the backside. Each of the other guide plates 12″ has a crotch portion 12″C on the backside.

Moreover, in the third embodiment, the guide plate 12″ has been pre-stressed but the guide plate 11″ has not been pre-stressed. That is, in this case, during assembly of the chain 10″, a pre-stress load or excessive tensile load is applied to the chain 10″ with the guide plates 12″ installed and the guide plate 11″ not installed. After pre-stress operation, the guide plate 11″ is installed into the chain 10″ to complete the entire chain.

According to the third embodiment, the guide plate 11″ is of relatively high rigidity without a crotch portion on the backside even though the plate has not been pre-stressed, whereas the other guide plate 12″ is of relatively low rigidity with a crotch portion on the backside that has been pre-stressed and subject to a residual compressive stress. As a result, the yield load of the guide plate 11″ or the timing plate can be made equal to that of the other guide plate 12″. In such a manner, the strength of the entire chain may be made uniform.

In the first and second embodiments, the guide plate is the timing plate, and the other guide plates have both been pre-stressed and subjected to a residual compressive stress, however in this case, the yield load of each of the guide plates differs from each other due to the differences in the backside shape of each of the guide plates.

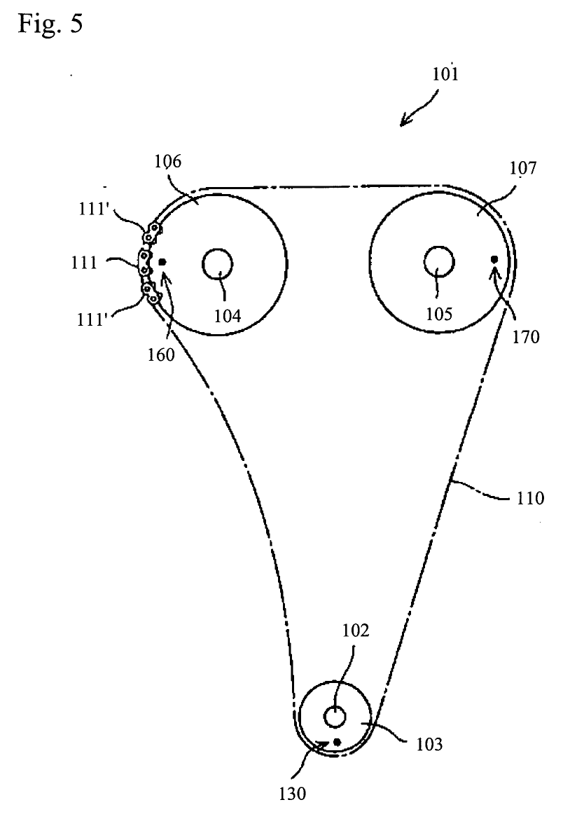

FIG. 5 shows an engine timing system of another embodiment employing a timing chain as a marked chain of the present invention. As shown in FIG. 5, the timing system 101 is constructed from a crank sprocket 103 mounted on a crankshaft 102, cam sprockets 106, 107 mounted on camshafts 104, 105, respectively, and a timing chain 110 wrapped around the sprockets 103, 106 and 107.

A timing mark 130 is marked on the crank sprocket 103 and timing marks 160, 170 on the cam sprockets 106, 107, respectively. The timing chain 1 10 has a guide plate 111 and a plurality of guide plates 112 on the outermost sides thereof. The guide plate 111 is disposed at a position corresponding to the timing mark 160 of the cam sprocket 106 and functions as a timing mark of the chain. A guide plate similar to the guide plate 111 may be disposed at positions corresponding to the other timing marks 130, 170.

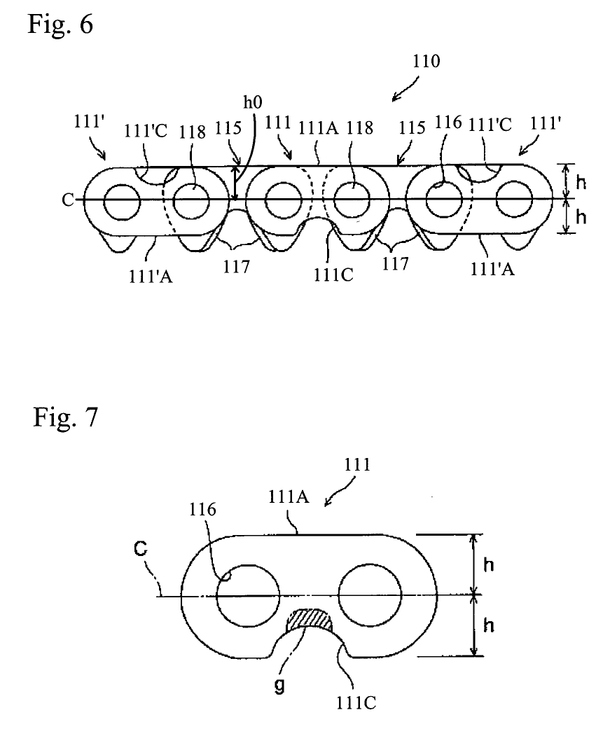

FIG. 6 shows a portion of the timing chain 1 10, which represents a fifth embodiment of the present invention. As shown in FIG. 6, the timing chain 110 includes of a plurality of rows of interleaved link plates 115 each having a pair of pin apertures 116 and teeth 117 and pivotably connected to each other by connecting pins 118 inserted into the pin apertures 116. The timing chain 101 also has guide plates 111, 111′ disposed outside the outermost link plates 115 and fixedly connected to the ends of the connecting pins 118.

The guide plate 111 has a crotch portion 111C on the engaging side and a flat portion 111A on the backside opposite the engaging side. The bottom portion of the crotch 111C of the guide plate 111 extends below the bottom portion of the crotch portion of the link plate 115. Thereby, as shown in FIG. 7, a hatched portion g of the crotch portion 111C has a guiding function to locate the chain 110 centrally on the sprocket during engagement with the sprocket.

The guide plate 111′ is the same plate as the guide plate 111 but placed upside down. That is, the guide plate 111′ has a flat portion 111′A on the engaging side and a crotch portion 111′C on the backside opposite the engaging side. The flat portion 111′A is disposed below the crotch portion 111C of the guide plate 111 to display a guiding function of the chain 110 during engagement with the sprocket.

As shown in FIG. 7, the length or distance extending from the pin aperture centerline C of the guide plate 111 to the flat surface 111A on the backside is h. The length extending from the pin aperture centerline C to the outer edge portion on the engaging side is also h. The lengths or distances h are the same. On the other hand, the length extending from the pin aperture centerline of the link plate 115 to the backside surface is h0, and the distance h0 is greater than or equals the distance h.

In the timing system 1 incorporating the above-mentioned timing chain 110, the guide plate disposed at a position corresponding to the timing mark of the sprocket is the same type of plate as the guide plate placed upside down. By using the same guide plates in different positions, the tensile strength of the guide rows and of the whole chain is equalized and uniformly maintained. Also, since the guide plate does not require a baking finish or plating, the manufacturing cost is reduced.

Moreover, in this case, when the guide plate is placed upside down, the outermost edge portion of the guide plate on the backside will not protrude outwardly from the backside surface of the link plate 115, thereby preventing the backside surface of the chain from locally contacting the tensioner arm or chain guide during operation. In such a way, local wear to the tensioner arm or chain guide is prevented.

In the above-mentioned embodiment, flat, generally U-shaped crotch portions 111A, 111′C were shown, but the present invention can be applied to various shapes including generally V-shape, round shape, or the like.

Also, the guide plate 111′ may be employed as a timing plate. That is, in this case, in FIG. 6, the positions of the guide plates 111, 111′ are exchanged.

Similar to the above-mentioned embodiment, all the guide plates have the same shape, thereby equalizing the tensile strength of the entire guide rows which uniformly maintains the tensile strength of the entire chain.

In the example of the above-mentioned embodiment, both of the lengths extending from the pin aperture centerline C of the guide plate to the backside surface and the engaging side surface are the same h, but the backside surface to the pin aperture centerline C or the engaging surface of the guide plate to the pin aperture centerline C may be shorter than the other.

In the above-mentioned first through sixth embodiments, a timing chain was shown as an example of the marked chain of the present invention. The present invention may also be applied to a random chain, where at least two kinds of link plates with different engagement pitches are arranged in a random pattern along the length of the chain. Here, the engagement pitch means a distance between the corresponding flank surfaces of the adjacent link plates along the engagement pitch line.

In this case, a guide plate (e.g. guide plate 11, 11′, 11″, 111, 111′, in each of the above-mentioned embodiments) having a different backside shape from the other guide plates may be disposed at a starting position of the random pattern.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

1. A chain for driving and engagement of at least one sprocket comprising:
a plurality of interlaced link plates pivotably connected by connecting pins; and
a plurality of guide plates disposed along the link plates that guide the chain on the sprocket in a width direction;
wherein at least one of the guide plates is a marked guide plate with a flat portion and a crotch portion, and is in line with a marked position on the sprocket.

2. The chain of claim 1, wherein the plurality of guide plates further comprises a flat portion on an engagement side with the sprocket and a flat portion on a backside of the guide plates.

3. The chain of claim 1, wherein the plurality of guide plates further comprises a flat portion on an engagement side with the sprocket and a crotch portion on a backside of the guide plate.

4. The chain of claim 3, wherein the marked guide plate has a flat portion on the backside of the guide plate.

5. The chain of claim 1, wherein all of the plurality of guide plates have been pre-stressed except for the marked guide plate.

6. The chain of claim 1, wherein the crotch portion of the marked guide plate is on the backside of the marked guide plate.

7. The chain of claim 1, wherein the flat portion of the marked guide plate is on the backside of the marked guide plate.

8. The chain of claim 1, wherein the plurality of guide plates further comprise a backside, a plurality of first pin apertures and a first pin aperture centerline; and the plurality of link plates further comprise a plurality of second pin apertures, a second pin aperture centerline, and a backside surface thereof.

9. The chain of claim 8, wherein a distance between the first pin aperture centerline and the backside or the flat portion on the engagement side with the sprocket of the plurality of guide plates is equal or smaller than a distance between the second pin aperture centerline and the backside surface of the plurality of link plates.

10. The chain of claim 8, wherein a distance between the first pin aperture centerline of and the backside is equal to a distance between the first pin aperture centerline and the engagement side of the plurality of guide plates.

11. The chain of claim 1, wherein the chain is a random chain.

12. A method of manufacturing a chain for driving and engagement of at least one sprocket comprising the steps of:
a) providing a plurality of interlaced link plates pivotably connected by connecting pins; and a plurality of interlaced guide plates disposed along the plurality of link plates that guide the chain on the sprocket in a width direction;
b) pre-stressing the plurality of interlaced guide links and the plurality of interlaced link plates; and
c) installing at least one guide plate that is a marked guide plate with a flat portion and a crotch portion in line with a marked position on the sprocket that has not been pre-stressed.
